(19) United States
(12) Patent Application Publication
(10) Pub. No.: US 2009/0282076 A1
(43) Pub. Date: Nov. 12, 2009

(54) PLAYLIST PROCESSING

(75) Inventors: Christopher WERSTIUK, Winnipeg (CA); Gordon Pusnik, Ontario (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Library Video Company, Wynnewood, PA (US)

(21) Appl. No.: 12/116,509

(22) Filed: May 7, 2008

(51) Int. Cl. G06F 17/00; G06F 17/30

(52) U.S. Cl. 707/104.1; 707/E17.009

(57) ABSTRACT

A playlist having an entry that points to a media file in a first format is processed to be played at a client that has a player suitable for rendering files of a second format. A primary description file of the media file is generated at a server. The description file can be used by a second format player to render the first format media file. When a request for the playlist is received at the server from the client, a secondary description file is generated that points to the location of the media file. The server replaces the playlist entry pointing to the media file with an entry pointing to the location of the secondary file. When the client plays the entry from playlist, the client requests and receives the secondary description file, which the client uses to find and render the media file using the second format player.

### FIELD OF THE INVENTION

The field of the invention is electronic media, and in particular the use of playlists in distributing and rendering media.

### BRIEF DESCRIPTION OF THE DRAWINGS

FIG. 1 shows a system in accordance with an embodiment of the present invention.

FIG. 2 shows the method in accordance with an embodiment of the present invention.

### DETAILED DESCRIPTION

In accordance with an embodiment of the present invention, a playlist having an entry that points to a media file in a first format, such as a Windows media format, is processed to be played at a client that has a player suitable for rendering files of a second format, such as QuickTime. A primary description file of the media file is generated at a server. The description file can be used by a QuickTime player to render the Windows Media Video (WMV) format file. When a request for the playlist is received at the server from the client, a secondary description file is generated that points to the location of the Windows media file. The server replaces the playlist entry pointing to the Windows media file with an entry pointing to the location of the secondary file for the client. When the client plays the entry from playlist, the client requests and receives the secondary description file, which the client uses to find and render the Windows media file using the QuickTime player. Had the client with the QuickTime player processed the original playlist entry, it would have requested Windows media formatted content, which cannot be played on the QuickTime player without a description file. In accordance with an embodiment of the present invention, a client can play all or part of a media file stored on a server in Windows media format through a QuickTime player at the client.

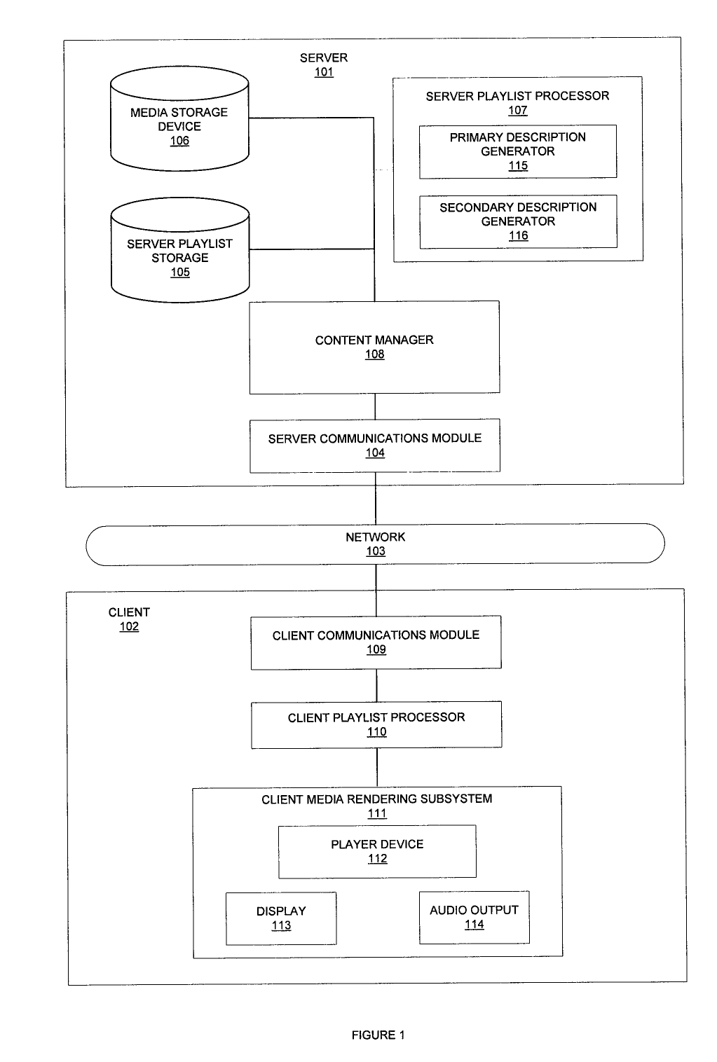

A system in accordance with an embodiment of the present is shown in FIG. 1. A server machine 101 is coupled to a client machine 102 through network 103.

Server 101 can include a server communications module 104, a server playlist storage device 105, media storage device 106, a server playlist processor 107 and content manager 108. The server communications module 104 can send and receive signals to and from client 102. For example, the server communications module 104 can receive a request from the client 102 for a playlist, send a signal to the playlist processor 107 based upon the request, receive the requested content from the playlist processor 107 and then send the requested playlist, properly formatted, to client 102. The playlist processor 107 can retrieve a playlist from the playlist storage device 105 and process it using the method in accordance with an embodiment of the present invention. The communications module 104 can also receive a request for content from client 102, send the request to the content manager 108, and then send the requested content received from the content manager 108 to client 102.

Client 102 can include a client communications module 109, client playlist processor 110 and a client media rendering subsystem 111 that can include a player device 112, a display 113 and an audio output device 114. The client communications module 109 can send and receive signals to and from server 101. The client playlist processor 110 can read entries in a client playlist and send signals to the client communications module 109 that cause requests for content referenced by the playlist to be sent from client to server communications module 104. Client communications module 109 can receive the requested content from server 101 and send it to the client media rendering subsystem 111. The player device 112 in the rendering subsystem can process electronic content and send the processed content as properly formatted signals to the display device 113 and the audio device 114.

Playlist processor 107 can include a primary description generator 115 and a secondary description generator 116. Content manager 108 can send to the primary description generator 115 a request to generate a primary description file based upon a media file that is pointed to in a playlist, along with arguments such as a path to the media file and a path to which to output the primary file description. These paths establish the locations of the media file and the location of the primary description file, respectively. By generating the primary description file before a client request for the playlist that includes the media file, the client 102 need not wait the full time needed to generate such a primary description file in response to the request.

The primary description generator 115 can generate the primary description file. Such a description file enables the media file to which the playlist entry points to be rendered at the client 102 using a player device 112 for rendering media files of a different format. For example, in one embodiment of the present invention, the playlist entry points to a media file stored at media storage device 106 in a Windows Media Video (WMV) format and the player device 112 on the requesting client 102 is a QuickTime player. A WMV file can be media data encapsulated in the Advanced Systems Format (ASF) container format to use a WMV codec. A QuickTime file stores the description of its media separately from the media data. The description, or metadata, is called the movie resource, movie atom, or simply the movie, and contains information such as the number of tracks, the video compression format, and timing information. The movie resource also contains an index describing where all the media data is stored. In accordance with an embodiment of the present invention, the primary and secondary description files can be constructed to be QuickTime-compatible metadata files that point to video data stored in a WMV file so that video data can be played using a QuickTime codec.

To create the primary description file, the primary description generator 115 can scan the WMV file to extract information about the file, such as the following:

1. Duration in seconds

2. Number of streams

3. Stream type (video or audio)

4. Video stream width and height

5. Video stream samples per second

6. List of video stream sample durations

7. List of video stream keyframes

8. List of video stream sample sizes

9. List of video stream sample offsets

10. Video stream bits per pixel

11. Video stream codec id

12. Video stream image size

13. Video stream horizontal pixels per meter

14. Video stream vertical pixels per meter

15. Video stream colors used

16. Video stream important colors count

17. Video codec specific data

18. Video stream number

19. Video stream maximum data packet size

20. Audio stream number

21. Audio alternate group

22. Audio stream samples per second

23. List of audio stream sample durations

24. List of audio stream sample sizes

25. List of audio stream sample offsets

26. Audio stream number of channels

27. Audio stream sample per second

28. Audio stream bits per sample

29. Audio stream codec id

30. Audio stream average number of bytes per second

31. Audio stream block align

32. Audio stream codec specific data

33. Audio stream maximum data packet size

Data including this information can be used by the primary description generator 115 to construct the primary description file, which can be a QuickTime metadata file that can be used by a QuickTime codec to play the media data in the WMV file. The primary description file can include a pointer to the location of the media file, such as its location on the server or its location on another device, e.g., coupled to the server directly, through a LAN, through a WAN, through the Internet, etc. This pointer can be used by a process executing on the server itself to locate the file. The primary description file may also include start and stop points based upon the start and stop points in the playlist entry for the media file.

When a request is received from a client 102 for a playlist, the playlist is processed by server playlist processor 107 in accordance with an embodiment of the present invention. The content manager 108 can send a request to cause the secondary description generator 116 to generate a secondary description file. The request can include arguments such as the path to the pregenerated primary description file that was created by the primary description generator 115, the path to which to output the secondary description file and the path to the WMV video file relative to the client that will play it when it renders the playlist. The arguments can also include start and stop times extracted from the playlist entry. Other arguments can also be included. For example, an argument can include a specific language request. This can cause the exclusion of language streams other than the requested one.

The playlist entry can be modified or replaced to point to the secondary description file. When the client 102 plays the playlist, player device 112 can send requests for content to server 101, which can send content from the WMV file in response. The content received at client 102 can be played on the client 102 using player device 112, e.g., a QuickTime player device.

The client 102 and server 101 can include a microprocessor in communication with memory and a communications port. The client can include a display, such as a Samsung 2493HM 24-Inch LCD Monitor, and an audio output device, such as the Logitech X-540 speaker system, both of which can be in communication with the microprocessor and/or a separate display and audio processor, respectively. The microprocessor can be a general purpose microprocessor, such as the Intel Core 2 Extreme QX9650 Yorkfield 3.0 GHz 12 MB L2 Cache LGA 775 130W Quad-Core Processor. Microprocessor can also be an Application Specific Integrated Circuit (ASIC) that embodies at least part of the method in accordance with an embodiment of the present invention in hardware and/or firmware. The microprocessor can be implemented across a combination of individual processors, such as one or more general purpose microprocessors, one or more ASICs, graphics, display and audio processors, etc. Memory can be any suitable device for storing electronic information, such as RAM, ROM, a hard disk, flash memory, etc. Memory can store playlists, electronic media and instructions adapted to be executed by the microprocessor to perform at least part of the method in accordance with an embodiment of the present invention. For example, the instructions can be executed on the microprocessor to determine that an entry of a server version of a playlist that is stored in memory entry points to a media file in a first format. The instructions can further be executed to generate a primary description file that contains information about at least one aspect of the media file and store it in memory. The primary description file can be compatible with a player that renders files in a second format and not in the first format. When a request for the playlist is received from the client, the instructions can cause the microprocessor to create a secondary description file based upon the primary description file and store it in memory. Executing the instructions stored in memory, the microprocessor can build the secondary description file to include information about the location of the media file. A client version of the playlist can be created that has a client version playlist entry that points to the secondary description file. This version of the playlist can be sent to the client. The client can then play the playlist by rendering the content to which entries in the playlist refer.

Some or all of the entries on a playlist can be processed in the same way. A client version of the playlist can thus be generated, with some entries containing pointers to media files on the server that the client player can natively render. Other entries in the client version of the playlist can contain pointers to secondary description files that can be quickly generated based upon cached, pre-generated primary description files of media content in formats that the client player cannot natively render. As a result, a client player can render content stored in various formats at the server.

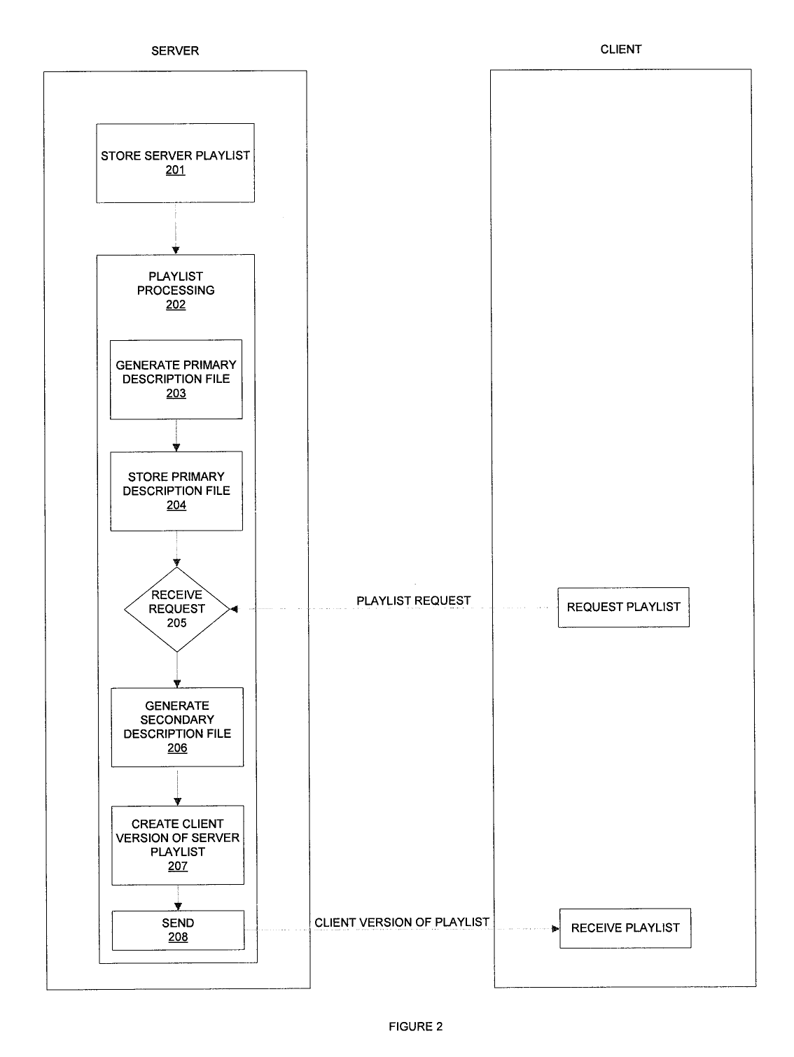

An embodiment in accordance with the method of the present invention is shown in FIG. 2. A server version of the playlist can be stored that has a playlist entry including location data for a media file, step 201. The playlist is processed at the server, step 202, during which it is discovered that an entry in the playlist points to a media file in a first format. A primary description file can be generated at step 203 during playlist processing that can be used by a player device that renders files in a second format and not natively in the first format. The primary description file can be compressed and stored at the server, step 204. A request for the playlist can be received at the server, step 205. In response to the request, a secondary description file can be generated based on the first description file, step 206. The secondary description file can include information about the location of the media file relative to the requesting client. A client version of the playlist can be created, step 207, in which the entry pointing to the media file in the server version of the playlist is replaced with an entry pointing to the secondary description file. The client version of the playlist can be sent to the client, step 208.

The foregoing is meant to illustrate and not to limit the scope of the present invention. Those of skill in the art will recognize that the claims encompass embodiments other than those described above. For example, the server playlist entry may point to a media file of the same format as that supported by a player at a client that has requested the server version of the playlist. The server can process the media file to form a description file. For example, a QuickTime media files can be processed to form a description file. When the client with the QuickTime player requests the playlist, the server version of the playlist can be processed by, without limitation, detecting playlist entries that point to QuickTime media files, replacing each such entry with a client version of the entry that points to the description file for the media file. The client version of the playlist can then be sent to the requesting client. When the client plays the client version of the playlist, it requests content based upon the description file, rather than based directly on the media file. Thus, an embodiment of the present invention can operate on media files of the same format as that supported by a client player. That is, the format the media file need not be different from the format supported by the client player. Start and end points that are specified in a server version playlist entry can be placed into the client version playlist entry, or embedded in the description file.

What is claimed is:

1. A method for processing a playlist having at least one playlist entry that includes information pertaining to a location of a media file containing playable content, comprising:
storing a server version of the playlist comprising at least one server version playlist entry including information pertaining to the location of the media file;
determining that the server version playlist entry points to the media file in a first format;
in response to determining that the server version playlist entry points to the media file in the first format, generating a primary description file that contains information about at least one aspect of the media file and that is compatible with a player that renders files in a second format and not in the first format;
storing the primary description file;
receiving from a client a request for the playlist;
creating a secondary description file based upon the primary description file and storing the secondary description file, the secondary description file comprising information pertaining to the location of the media file; and
creating a client version of the playlist having a client version playlist entry that includes location information pointing to the secondary description file, the client version playlist entry corresponding to the server version playlist entry that includes information pertaining to the location of the media file.

2. The method of claim 1, wherein the server version playlist entry further comprises a start point and an end point, the start point indicating where to start playing the content in the media file, the end point indicating where to stop playing the content in the media file.

3. The method of claim 1, wherein the secondary description file further comprises a start point and an end point, the start point indicating where to start playing the content in the media file, the end point indicating where to stop playing the content in the media file.

4. The method of claim 1, wherein the first format is a Windows media format and the second format is a QuickTime format.

5. The method of claim 1, wherein secondary description information pertaining to the location of the media file comprises a path from the requesting client to a location on a server at which the media file is stored.

6. The method of claim 1, further comprising sending the client version of the playlist to the client.

7. The method of claim 1, further comprising:
receiving from a client a request for content in the media file in the first format, the request based upon the secondary description file; and
sending to the client in response to the request content from the media file that can be rendered using a player that renders media files in a second format different than the first format.

8. A system for playlist processing, comprising
a server playlist database that stores a server playlist that has at least one server playlist entry that points to a media file;
a media storage device that stores the media file to which a playlist entry points;
a playlist processor in communication with the playlist storage device, the playlist processor comprising a primary description generator and a secondary description generator, where the playlist processor detects the format of the media file to which the playlist entry points and determines that the file is in a first format, causes the primary description generator to create and store a primary description file, causes the secondary description generator to generate and store a secondary description file based on the primary description file that can be used by a player that does not natively render in the first format to render the media file, modifies the playlist entry to point to the location of the stored secondary description file instead of the media file; and
a content manager in communication with the playlist processor, the media storage device and a server communications manager, where the content manager receives through the server communications manager a request for the playlist from the client, causes the playlist processor to process the server playlist to create a client version of the playlist and causes the client version of the playlist to be sent through the server communications manager to the client.

9. The system of claim 8, wherein the server playlist entry has a start point and an end point, the start point indicating where to start playing the content in the media file, the end point indicating where to stop playing the content in the media file, and wherein the secondary description generator creates a secondary description file start point and a secondary description file end point in the secondary description file.

10. The system of claim 8, wherein the secondary description generator creates the secondary description file to include the location of the media file at the server.

11. A method for processing a playlist having at least one playlist entry that includes information pertaining to a location of a media file containing playable content, comprising:
storing a server version of the playlist comprising at least one server version playlist entry including information pertaining to the location of the media file;
receiving from a client a request for the playlist;
determining that the server version playlist entry points to the media file;
in response to determining that the server version playlist entry points to the media file, generating a description file that contains information about at least one aspect of the media file and that is compatible with the client player; and
creating a client version of the playlist having a client version playlist entry that includes location information pointing to the description file, the client version playlist entry corresponding to the server version playlist entry that includes information pertaining to the location of the media file.

12. The method of claim 11, wherein the server version playlist entry further comprises a start point and an end point, the start point indicating where to start playing the content in the media file, the end point indicating where to stop playing the content in the media file.

13. The method of claim 11, wherein the description file further comprises a start point and an end point, the start point indicating where to start playing the content in the media file, the end point indicating where to stop playing the content in the media file.

14. The method of claim 11, wherein the server playlist entry has a start point and an end point, the start point indicating where to start playing the content in the media file, the end point indicating where to stop playing the content in the media file and wherein the corresponding client version playlist entry has a corresponding start point and a corresponding end point.
